(19) United States
(12) Patent Application Publication
(10) Pub. No.: US 2025/0345237 A1
(43) Pub. Date: Nov. 13, 2025

(54) RESTRAINTS WITH SENSORS FOR MECHANICAL CPR DEVICE

(71) Applicant: PHYSIO-CONTROL, INC., Redmond, WA (US)

(72) Inventors: Marcus Ehrstedt, Kävlinge (SE); Steven B. Duke, Bothell, WA (US); Rose T. Yin, Bellevue, WA (US); Tyson G. Taylor, Bothell, WA (US)

(73) Assignee: PHYSIO-CONTROL, INC., Redmond, WA (US)

(21) Appl. No.: 19/202,723

(22) Filed: May 8, 2025

Related U.S. Application Data
(60) Provisional application No. 63/645,028, filed on May 9, 2024.
(60) Provisional application No. 63/651,353, filed on May 23, 2024.

(51) Int. Cl. A61H 31/00

(52) U.S. Cl. CPC A61H 31/006; A61H 31/005; A61H 2201/1611; A61H 2201/1638; A61H 2203/0456; A61H 2230/06; A61H 2230/08; A61H 2230/205; A61H 2230/207; A61H 2230/30

(57) ABSTRACT

A restraint configured to secure a patient to a mechanical cardiopulmonary resuscitation (“CPR”) device. The restraint includes a physiological sensor configured to detect a physiological parameter of the patient and to output a signal indicative of a value of the physiological parameter.

### PRIORITY

This disclosure claims the benefit of U.S. Provisional Application No. 63/645,028, filed on May 9, 2024, and U.S. Provisional Application No. 63/651,353, filed on May 23, 2024, both of which are incorporated herein by reference in their entirety.

### TECHNICAL FIELD

The subject matter is related to CPR devices that deliver CPR chest compressions to a patient, and, more particularly, to a system and methods for detecting physiological parameters and other conditions using restraints having sensors.

### BACKGROUND

Cardiopulmonary resuscitation (CPR) is a medical procedure performed on patients to maintain some level of circulatory and respiratory functions when patients otherwise have limited or no circulatory and respiratory functions. CPR is generally not a procedure that restarts circulatory and respiratory functions, but can be effective to preserve enough circulatory and respiratory functions for a patient to survive until the patient's own circulatory and respiratory functions are restored. CPR typically includes frequent torso compressions that usually are performed by pushing on or around the patient's sternum while the patient is lying on the patient's back. For example, torso compressions can be performed as at a rate of about 100 compressions per minute and at a depth of about 5 cm per compression for an adult patient. The frequency and depth of compressions can vary based on a number of factors, such as valid CPR guidelines.

Mechanical CPR has several advantages over manual CPR. A person performing CPR, such as a medical first-responder, must exert considerable physical effort to maintain proper compression timing and depth. Over time, fatigue can set in and compressions can become less consistent and less effective. The person performing CPR must also divert mental attention to performing manual CPR properly and may not be able to focus on other tasks that could help the patient. For example, a person performing CPR at a rate of 100 compressions per minute would likely not be able to simultaneously prepare a defibrillator for use to attempt to correct the patient's heart rhythm. Mechanical compression devices can be used with CPR to perform compressions that would otherwise be done manually. Mechanical compression devices can provide advantages such as providing constant, proper compressions for sustained lengths of time without fatiguing, freeing medical personnel to perform other tasks besides CPR compressions, and being usable in smaller spaces than would be required by a person performing CPR compressions.

Some mechanical CPR devices may have restraints for securing patients' body parts to the CPR device. These restraints may be implemented for the patients' safety—for example, to keep patients' hands and arms away from the force of the compression mechanism during treatment—or for stabilizing patients' bodies within the CPR device to ensure effective delivery of treatment. Straps may be included with a CPR device to secure a patient's wrists to a portion of the device's support structure, for instance. Or, a strap may be included with a CPR device to hold a patient's neck and shoulders steady during delivery of compressions.

Additionally, sensors often provide important real-time insights into patients' health status in rescue settings, such as scenes of first response and transport to hospital facilities. The urgency in such settings makes it critical for rescuers to have reliable streams of information regarding a patient's health status, so rescuers can make informed decisions on the appropriate care to give the patient. These pre-hospital settings can be hectic, however, and typical sensors worn on patients' bodies can easily lose contact with the skin, cutting off the critical streams of information.

Configurations of the disclosed technology address shortcomings in the prior art.

### BRIEF DESCRIPTION OF THE DRAWINGS

FIG. 1 is a perspective view of a CPR device, according to an example configuration.

FIG. 2 is a perspective view of the CPR device of FIG. 1, implemented with wrist restraints, according to an example configuration.

FIG. 3 is a perspective view showing additional details of the wrist restraints of FIG. 2.

FIG. 4 is a side view of a CPR device implemented with wrist restraints and a neck restraint, according to an example configuration, further showing a representation of a patient.

FIG. 5 is a perspective view of the CPR device of FIG. 1, implemented with wrist restraints, according to an additional example configuration.

FIG. 6 is a side view of a CPR device implemented with the wrist restraints of FIG. 5, further showing a representation of a patient's arm and hand.

### DETAILED DESCRIPTION

As described herein, aspects are directed to sensors incorporated with restraints for mechanical cardiopulmonary resuscitation (CPR) devices. Such sensors, in configurations, monitor physiological parameters of a patient during CPR treatment, or a variety of other conditions, such as environmental conditions and performance parameters of the CPR device. Incorporating sensors with restraints, as discussed herein with regard to configurations of the disclosed technology, provide more consistent and reliable monitoring of information during use of CPR devices, as restraints configured to securely hold a patient's body in place may also securely maintain contact between the sensors and the patient's skin.

In particular, prior CPR devices implemented wrist restraints on a portion of a the device's support structure. These wrist restraints are typically configured to secure the patient's wrist—and, accordingly, the patient's arms and hands—in a position such that the patient's arms and hands do not enter the path of the CPR device's compression mechanism. In this way, these wrist restraints in prior CPR devices prevent injury to a patient by firmly holding the patient's wrists in place. In configurations of the disclosure, sensors are incorporated in these wrist restraints, providing reliable streams of information for rescuers and maintaining the necessary contact between the sensors and the skin of the patient's wrist.

Furthermore, prior CPR devices implemented stabilization straps configured to be positioned at the nape of a patient's neck and secured to the support structure of the CPR device. By stabilizing the patient's neck and thus limiting its movement, these stabilization straps also help to stabilize the patient's head and upper torso. Accordingly, these stabilization straps help maintain the position of the patient's body within the CPR device and limit movement that could hinder the performance of CPR by the device. In configurations of the disclosure, sensors are also incorporated in stabilization straps, providing an additional stream of information for rescuers in a position that maintains necessary contact between the sensors and the patient's skin.

In configurations, the information measured by the disclosed sensors is displayed to a rescuer on a display of the CPR device itself, or on a separate display. Additionally or alternatively, in configurations, the measurements are used as feedback for the CPR device, enabling the CPR device to adjust, start, or stop compressions based on the measurements received from the disclosed sensors.

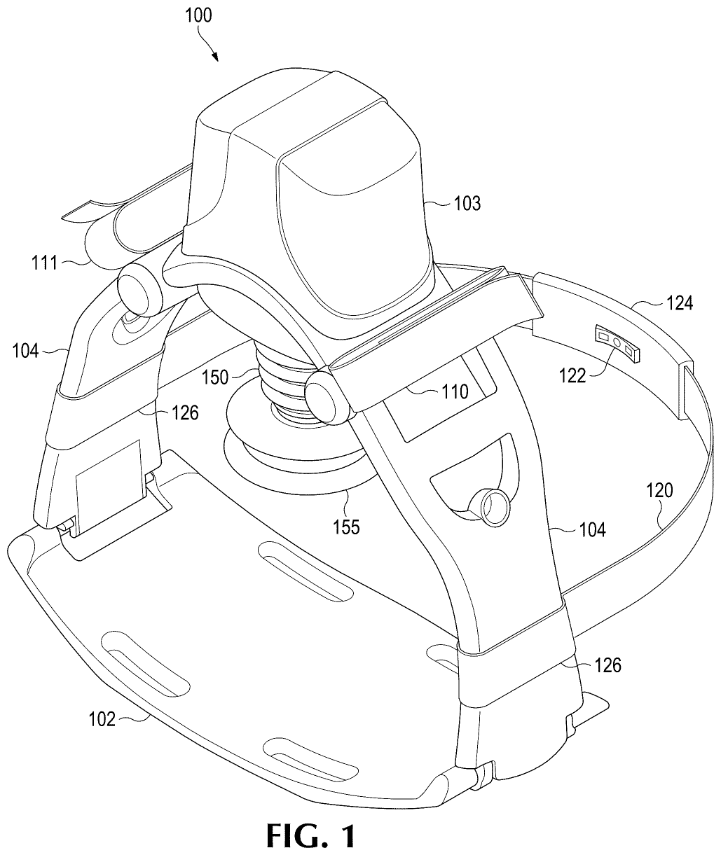

FIG. 1 is a perspective view showing portions of a CPR device 100, according to configurations. As illustrated in FIG. 1, the CPR device 100 includes a base member 102, a chest compression mechanism 103, and a support leg 104.

The chest compression mechanism 103 is configured to deliver CPR chest compressions to the patient 101. The chest compression mechanism 103 includes, for example, a motor-driven piston 150 configured to contact the patient's chest to provide the CPR chest compressions. The motor-driven piston 150 also includes a suction cup 155, in configurations.

The support leg 104 is configured to support the chest compression mechanism 103 at a distance from the base member 102. For example, if the base member 102 is underneath the patient, lying on their back, then the support leg 104 supports the chest compression mechanism 103 at a sufficient distance over the base member 102 to allow the patient to lay within a space between the base member 102 and the chest compression mechanism 103, while positioning the chest compression mechanism 103 over the patient's chest.

In configurations, two support legs 104 are provided. In configurations, the two support legs 104 together form an arch to support the chest compression mechanism 103. An example of such a configuration is illustrated in FIG. 1.

FIG. 1 also shows wrist restraints 110, 111 implemented with the CPR device 100. Wrist restraints 110, 111 are configured to secure a patient's wrists in position on the support legs 104, thereby preventing the patient from inadvertently moving their hands or arms in the path of the piston 150 while compressions are being performed. Specifically, wrist restraints 110, 111 are shown as attached to outer surfaces of the support legs 104 of the CPR device, at a portion of the support legs 104 nearest the compression mechanism 103. As shown, wrist restraints 110, 111 are positioned such that one restraint is attached to each support leg, in configurations having two support legs 104 forming an arch, such as the example illustrated in FIG. 1. In this way, when a patient lies supine—i.e., on their back—with the compression mechanism 103 positioned over their chest, each of the wrist restraints 110, 111 correspond to and secure one of the patient's wrists. For instance, wrist restraint 110 secures the patient's left wrist while wrist restraint 111 secures the patient's right wrist, in configurations, and vice versa in still other configurations.

With respect to the example shown in FIG. 1, a patient's wrists can be secured to the CPR device 100 with wrist restraints 110, 111 such that the palms of each of the patient's hands face the compression mechanism 103. In this way, a portion of the patient's wrists directly below the patient's palms interface with the portions of wrist restraints 110, 111 that are attached to the outer surfaces of the support legs 104. For the purposes of this disclosure, this portion of the patient's wrists below the palms is referred to as the patient's inner wrists. Although not illustrated in FIG. 1, wrist restraints 110, 111 include sensors for measuring physiological parameters or other information related to the patient's health status or general conditions during CPR treatment. The sensors, in configurations, are disposed in the portions of wrist restraints 110, 111 secured to the outer surfaces of the support legs 104. Accordingly, the sensors are disposed where the patient's inner wrists interface with wrist restraints 110, 111.

Because sensors are disposed where patient's inner wrists interface with wrist restraints 110, 111, in configurations, and because wrist restraints 110, 111 secure the patient's wrists in position and limit movement of the wrists, the patient's inner wrists remain consistently in contact with the sensors while the patient's wrists are secured with the wrist restraints 110, 111. Consequently, measurements taken by the sensors are not hindered or interrupted by loss of contact between the sensors and the skin of the patient's inner wrists while the necessary treatment is being performed.

In still other configurations, sensors are disposed on portions of wrist restraints 110, 111 that interface with other portions of a patient's wrists or hands. For instance, in configurations, wrist restraints 110, 111 include a glove for receiving a patient's hands. In such configurations including a glove, sensors may be disposed in portions of the glove interfacing with the patient's fingers, allowing for contact between the sensors and the skin of the patient's fingers.

FIG. 1 also shows a neck restraint 120 implemented with the CPR device 100. Neck restraint 120 is configured to support the nape of a patient's neck when the patient is lying on their back and positioned within the CPR device 100 such that the compression mechanism 103 is over their chest. As shown, neck restraint includes sensors 122 disposed on a pad 124, which is structured to interface with the nape of the patient's neck. Neck restraint 120, in configurations, is secured to the support legs 104 at attachment ends 126, 127.

In configurations, attachment ends 126, 127 are loops in the neck restraint 120 material that are structured to wrap around the support legs 104, as illustrated in FIG. 1. Attachment ends 126, 127 are permanently wrapped around the support legs 104, in configurations, such that the neck restraint 120 is a permanent component of the overall CPR device. Alternatively, in configurations, the attachment ends 126, 127 are detachable from the support legs 104, such that the neck restraint 120 is a removable component that may or may not be implemented with the CPR device at a user's discretion. In still other configurations, attachment ends 126, 127 are not loops in the neck restraint material. Rather, attachment ends 126, 127 are structured to hook, buckle, adhere, or otherwise fasten to the support legs 104, either permanently or removably, in configurations.

When the patient is positioned within the CPR device 100, the nape of the patient's neck contacts and rests against a surface of the pad 124 open toward the CPR device 100. As mentioned, the patient may be lying on their back on base member 102 when positioned within the CPR device 100, and the patient's head will thus tend toward resting on a surface beneath the patient, such as the ground or a stretcher. With the patient's neck contacting pad 124 of the neck restraint 120, the weight of the patient's head tending toward the surface beneath the patient works to tension the neck restraint 120. When the neck restraint 120 is tensioned in this way, the neck restraint 120 stabilizes the patient's head and upper torso by limiting movement of the patient's neck. In turn, neck restraint 120 works to maintain the patient's body position as compressions are performed, ensuring that compressions are delivered to a desired location on the patient's chest and limiting the potential to drift from the desired location. Additionally, the weight of the patient's head acting against pad 124 at the nape of the patient's neck ensures the patient's neck remains in place against the pad 124.

The surface of pad 124 open toward the CPR device 100 and interfacing with the nape of the patient's neck may also be the surface on which sensors 122 are disposed. Accordingly, because the weight of the patient's head maintains the patient's neck against pad 124, the skin of the patient's neck is consistently in contact with the sensors 122 while the patient's body is positioned within the CPR device 100. Thus, similar to the interfacing just described with regard to wrist restraints 110, 111, measurements can be taken with sensors 122 without hindrance or interruption due to loss of contact with the patient's skin. In configurations, neck restraint 120 is adjustable to accommodate patients of various sizes and maintain the described tension regardless of the patient's size. In other words, the length of neck restraint 120 between attachment points 126, 127 is able to be lengthened or shortened to ensure the neck restraint 120 is not so loose as to lose contact with the patient's skin.

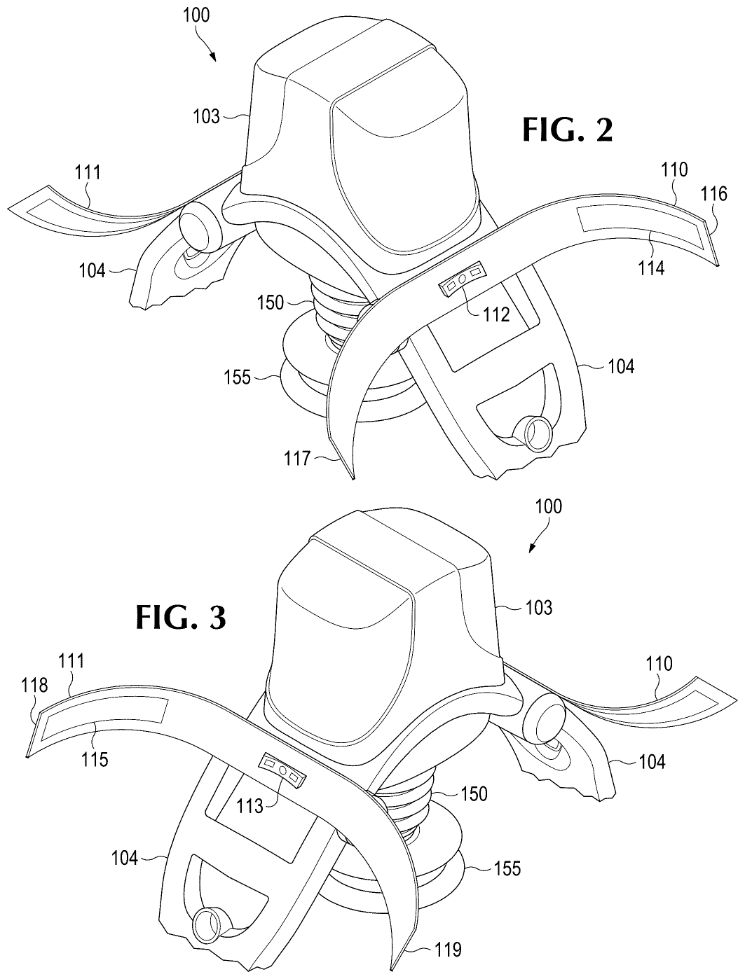

FIG. 2 is a cutaway perspective view of the CPR device 100 of FIG. 1, showing further details of wrist restraints 110, 111. In particular, FIG. 2 shows wrist restraints 110, 111 in a position to receive a patient's wrist, with wrist restraint 110 in the foreground. As shown, wrist restraint 110 has sensors 112 disposed on a surface opposite where the restraint 110 is attached to support leg 104. As mentioned the location of the sensors 112, in configurations, corresponds to the location at which a patient's inner wrists interface with wrist restraint 110. Consequently, when one of patient's wrists is secured in wrist restraint 110, the skin of the patient's wrist is consistently in contact with the sensors 112.

In configurations, such as the example illustrated in FIG. 2, wrist restraint 110 comprises an elongated strip having a first end 116 and a second end 117. Additionally, wrist restraint 110 comprises a fastener 114 positioned at least at the first end 116, configured to secure the first end 116 to the second end 117. In this way, when a patient's wrist is positioned to be secured in place by wrist restraint 110, the first end 116 and second end 117 close around the patient's wrist, and the fastener 114 secures the first end 116 and the second end 117. In configurations, fastener 114 is a hook-and-loop fastener, such as the one sold under the brand name VELCRO®. In such configurations where fastener 114 is a hook-and-loop fastener, fastener 114 at the first end 116 includes hooks, and the second end 117 also includes a fastening component—namely, a component having loops to receive the hooks.

Still, fastener 114 takes other forms, in configurations of the disclosed technology. For instance, fastener 114 instead comprises a buckle, in configurations, such as a pin-and-frame buckle, an O-ring, a D-ring, a snap buckle, or another type of buckle known for joining two ends. In still other configurations, fastener 114 comprises ties, buttons, snap buttons, clasps, or any other suitable means of joining two ends.

As mentioned, the first end 116 and the second end 117 of wrist restraint 110 are two ends of the same elongated strip, in configurations such as the example illustrated in FIG. 2. Consequently, modes of fastening the first end 116 and second end 117 of wrist restraint 110 have been described as joining two ends of one component. However, configurations of the disclosed restraints take other forms. For instance, wrist restraint 110, in configurations, is instead formed of two separate strips fixed to the support leg 104 at an end of each strip and configured to be joined together at the opposite end. Joining the ends of two separate strips may be accomplished in any of the ways just described with regard to FIG. 2. In still other configurations, wrist restraint 110 is a single, closed-loop piece. In this way, wrist restraint 110 can be imagined as a bracelet configured to receive a patient's wrist.

Additionally, a variety of materials can be used to form wrist restraint 110. Wrist restraint 110, in configurations, is flexible and is formed of a woven fabric like woven nylon. Other flexible materials are also used to form wrist restraint 110, in configurations, such as cordage, flexible metal cable, plastic webbing, or other known materials. In this way, wrist restraint 110 can also be adjustable and conformable to a patient's wrist size and shape when the patient's wrist is secured within wrist restraint 110. Conversely, in alternative configurations, wrist restraint 110 is rigid. For example, in configurations implementing a single, closed-loop piece of material to form wrist restraint 110, wrist restraint 110 is a rigid metal bracelet, configured to receive the patient's wrist and limit movement of the patient's wrist while received. In such configurations, wrist restraint 110 substantially encircles the patient's wrist. For the purposes of this disclosure, “substantially encircles” means largely or essentially forming a circle around, without requiring perfect circularity.

In any of the disclosed configurations, wrist restraint 110 is structured to hold one of patient's wrists in place at a portion of the CPR device's support structure nearest the compression mechanism 103, which, as shown, is enclosed in a housing. Accordingly, wrist restraint 110 limits the motion of the corresponding arm and hand, preventing the patient's arm or hand from entering the path of piston 150 and suction cup 155 during compressions. Furthermore, because movement of the patient's arm and hand are limited by wrist restraint 110, the patient's inner wrists maintain consistent contact with the sensors 112 disposed on wrist restraint 110 as compressions are performed. Thus, the implementation of sensors 112 with wrist restraint 110 provides for reliable measurement of physiological parameters or other conditions related to the compressions.

Sensors 112, in configurations, comprise one or more known sensing devices, or any combination of known sensing devices. For example, in configurations, sensors 112 comprise one or more sensing devices configured to measure physiological parameters of the patient, such as non-invasive blood pressure cuffs, electrocardiograms (ECG), oximeters for detecting blood oxygen saturation, pulse sensors, or capnographic sensors for sensing end-tidal carbon-dioxide levels. In configurations implementing capnographic sensors, tubing is provided to direct a patient's exhaled breath to the location of the capnographic sensors. Additionally or alternatively, sensors 112 comprise ultrasound and/or doppler sensors, plethysmographs, interferometers, or sensors to measure light absorbance and/or transmission.

Although not illustrated in FIG. 2, in configurations, sensors 112 are electrically connected to the CPR device 100 such that measurements taken by sensors 112 are capable of being displayed to a rescuer. For instance, measurements can be displayed to a rescuer on a display integrated with the CPR device itself, or measurements can be displayed on a separate monitor or display that is also electrically connected to the CPR device 100. In configurations, electrical connection between sensors 112 and the CPR device 100 is provided via a wired connection. In alternative configurations, sensors 112 are electrically connected with the CPR device 100 via a wireless connection. Because sensors 112 maintain consistent contact with the patient's inner wrist, as described above, the measurements displayed to the rescuer provide reliable information that minimizes the presence of interruptions or inaccuracies.

Additionally, it should be noted that sensors 112, in configurations, comprise multiple sensors disposed in the same location of the restraints. For instance, configurations of sensors 112 include more than one electrode for recording ECG. Having more than one electrode, in this way, allows for separation of a motion artifact from the ECG. In other words, artifacts in ECG signals caused by compressions or other movement of the patient's body during treatment can be separated from the ECG signals to generate higher quality ECG data for the rescuer.

With specific regard to sensors 112 comprising a non-invasive blood pressure cuff, implementation of the blood pressure cuff with wrist restraint 110 also improves the accuracy of blood pressure readings. More specifically, implementing a blood pressure cuff with a restraint at a known location of the CPR device 100 having a known geometry allows for adjusting blood pressure readings relative to that known geometry. The CPR device 100, for instance, has known dimensions. With these known dimensions, the height at which a patient's wrist is secured within wrist restraint 110 may also be known. With a known height of the patient's wrist, a hydrostatic pressure corresponding to the patient's wrist being held at that height can be accounted for in the measurement of the patient's blood pressure.

Additionally or alternatively, measurements made by sensors 112, in any of the configurations described above, are used as feedback for the CPR device 100. In this way, sensors 112 can output signals indicative of the values of the parameters measured and/or detected, and a controller or processor of the CPR device 100 is configured to receive the outputted signals from sensors 112 and analyze the signals with regard to the compressions being performed. The controller or processor of the CPR device 100 is configured to cause the compression mechanism 103 to drive the piston 150 toward the chest of the patient—or, compress the chest—according to a treatment profile. In configurations, the treatment profile comprises compression depth, compression force, compression duration, and compression speed. Additionally or alternatively, the controller or processor is configured to retract the piston from the patient's chest, in configurations. Accordingly, in configurations, the treatment profile further includes retraction distance, lifting force, retraction duration, or retraction speed.

Furthermore, in configurations, the CPR device 100 generates a signal indicative of the actions being performed—e.g., a signal indicating the position of the piston over time. In such configurations, the signal indicative of the actions of CPR device 100 can be outputted in combination with the data from sensors 112. Accordingly, data from sensors 112 can be synchronized with data regarding the actions of the CPR device 100. Synchronizing the data in this way allows for precise understanding of the effects the CPR device 100 has on a patient, enabling signal analysis to target and ultimately influence specific periods of the piston's movement during treatment.

The controller or processor can thus determine, based on the received signals, to start, stop, or adjust the treatment profile. More specifically, the CPR device can adjust compression parameters such as compression location, pace, duty cycle, waveform, and depth—in addition to any of the treatment profile features described above—based on the signals outputted by sensors 112. This processing of signals from the sensors 112 and adjusting compressions can then iterate repeatedly, until optimal or desired compression parameters are reached.

Referring again to FIG. 2, wrist restraint 110 is structured to secure one of a patient's wrists to the CPR device 100. In this way, wrist restraint 110 is structured to secure either of a patient's left or right hands, depending on the orientation of the patient's body within the CPR device 100. As shown in FIG. 2, and as previously discussed, CPR device 100 also includes wrist restraint 111. Wrist restraint 111 is attached to a support leg 104 opposite the one to which wrist restraint 110 is attached, and thus wrist restraint 111 is configured to secure a wrist of the patient opposite the one secured by wrist restraint 110. For example, wrist restraint 110 secures a patient's left wrist, while wrist restraint 111 secures a patient's right wrist, in configurations, and vice versa in still other configurations.

Referring now to FIG. 3, wrist restraint 111 is shown as including the same features and details just discussed with regard to wrist restraint 110 and FIG. 2. FIG. 3 is a cutaway perspective view showing those features and details applied to wrist 111. As shown, wrist restraint 111 has sensors 113 disposed on a surface opposite where the wrist restraint 111 is attached to the support leg 104, and thus the patient's wrist is consistently in contact with sensors 113 when the patient's wrist is secured in wrist restraint 111.

Similar to wrist restraint 110, wrist restraint 111 also comprises an elongated strip having a first end 118 and a second end 119, in configurations such as the example illustrated in FIG. 3. Additionally, wrist restraint 111 comprises a fastener 115 positioned at least at the first end 118, configured to secure the first end 118 to the second end 119. In this way, when a patient's wrist is positioned to be secured by wrist restraint 111, the first end 118 and the second end 119 closes around the patient's wrist, and the fastener 115 secures the first end 118 and the second end 119. Fastener 115, in configurations, takes any of the forms described above with regard to fastener 114 of FIG. 2.

In alternative configurations, the first end 118 and the second end 119 of wrist restraint 111 are not two ends of the same strip, but are instead formed of two separate strips fixed to the support leg 104 at an end of each strip, as described above with regard to wrist restraint 110. Joining the ends of two separate strips, in such configurations, can be accomplished in any of the ways just described with regard to fastener 114 of FIG. 2. And, in still other configurations, wrist restraint 111 is a single, closed-loop piece. In this way, wrist restraint 111 can be imagined as a bracelet configured to receive a patient's wrist. Finally, materials described above with regard to configurations of wrist restraint 110 are applicable to configurations of wrist restraint 111, and thus configurations of wrist restraint 110 and wrist restraint 111 are formed from the same materials.

In any of the disclosed configurations, wrist restraint 111 is structured to hold one of patient's wrists in place at a portion of the CPR device's support structure nearest the compression mechanism 103. Specifically, in configurations such as the example shown in FIGS. 2 and 3, wrist restraint 111 is structured to hold a wrist on the opposite side of the patient's body relative to the wrist held by wrist restraint 110. Accordingly, wrist restraint 111 limits the motion of the corresponding arm and hand, preventing the patient's arm or hand from entering the path of piston 150 and suction cup 155 during compressions. Furthermore, because movement of the patient's arm and hand are limited by wrist restraint 111, the patient's inner wrists maintain consistent contact with the sensors 113 disposed on the wrist restraint 111. Thus, implementation of sensors 113 with wrist restraint 111 provides for reliable measurement of physiological parameters or other conditions related to the compressions.

Sensors 113, in configurations, comprise one or more known sensing devices, or any combination of known sensing devices described above with regard to sensors 112 of FIG. 2. Additionally, although not illustrated in FIG. 3, in configurations of the CPR device 100, sensors 113 are electrically connected to the CPR device 100 such that measurements taken by sensors 113 are capable of being displayed to a rescuer. As mentioned with regard to sensors 112 of FIG. 2, sensors 113 comprising a non-invasive blood pressure allow for improved blood pressure readings, due to the known geometry of the CPR device 100 and the known height of the patient's wrists secured within wrist restraint 111. Additionally or alternatively, in configurations, measurements made by sensors 113 are used as feedback for the CPR device, just as described above with regard to sensors 112 of FIG. 2.

In configurations, sensors 112 of wrist restraint 110 and sensors 113 of wrist restraint 111 are of the same type of sensor and are configured to make the same physiological measurements. In this way, the measurements from each of sensors 112 and sensors 113 can be used to determine the reliability of the measurements. For example, in configurations, sensors 112 and sensors 113 are configured to measure pulse oximetry. If sensors 112 and sensors 113 measure the same levels of oxygen in the patient's blood during treatment, or if sensors 112 and sensors 113 measure oxygen levels above a predetermined threshold of correlation relative to each other, the measurements are considered reliable and are reported to the rescuer. If, however, pulse oximeters implemented as sensors 112 and sensors 113 measure oxygen levels below a predetermined threshold of correlation relative to each other, the measurements are considered less reliable or unreliable. Reporting of less reliable or unreliable measurements, in configurations, follow strategies discussed in U.S. Patent Application Publication 2024/0065576 A1, attached here as Appendix A.

Additionally or alternatively, sensors 112 of wrist restraint 110 and sensors 113 of wrist restraint 111 are of different types and are configured to make different measurements. For example, in configurations, sensors 112 comprise a non-invasive blood pressure cuff configured to measure a patient's blood pressure during compressions, and sensors 113 comprise pulse oximeters configured to measure oxygen levels in the patient's blood. Implementing different sensors in this way allows for both measurements to be taken simultaneously during treatment. Without sensors different sensors disposed at different locations, in this way, simultaneous measurements of different types could not always be performed. For instance, with regard to the example just discussed, blood pressure measurements and pulse oximetry could not be simultaneously performed in the same sensor location, as the non-invasive blood pressure cuff would cut off blood flow to the wrist at which the sensors are disposed and prevent measurements from being obtained by a pulse oximeter.

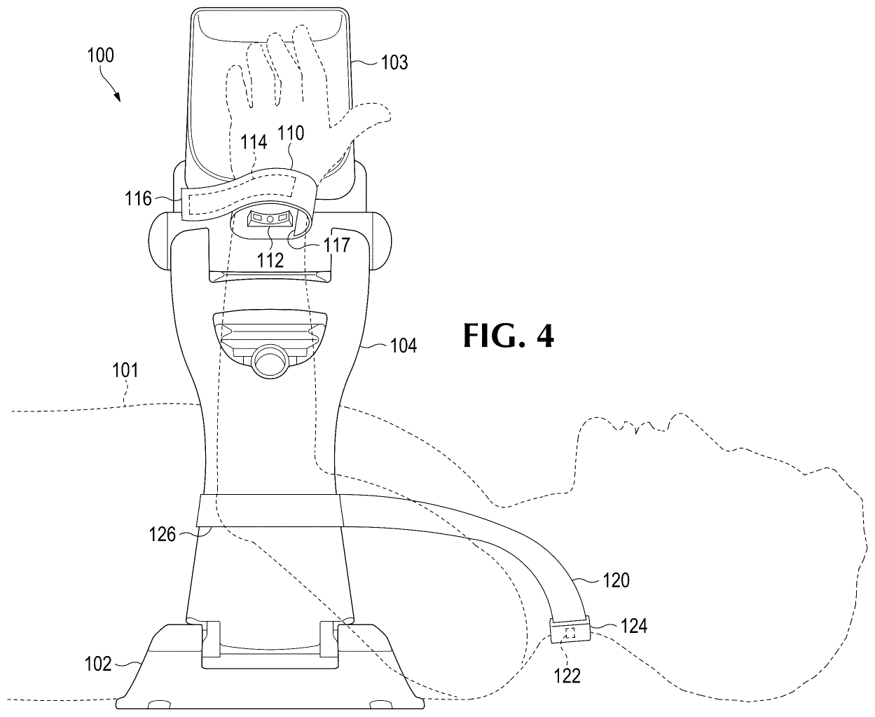

FIG. 4 shows a side view of the CPR device 100 with a representation of a patient 101 positioned within the CPR device 100. With reference to FIG. 4, base member 102 can be imagined as sitting on a surface, such as the ground, and thus the patient 101 is pictured lying supine. Additionally, FIG. 4 shows wrist restraint 110 and neck restraint 120 implemented with the CPR device 100. Although an additional wrist restraint, such as wrist restraint 111 of FIG. 3, is not shown in FIG. 4, configurations of the CPR device 100 such as the one illustrated in FIG. 4 include a second wrist restraint opposite wrist restraint 110. In this way, a second wrist restraint is implemented with the CPR device 100 shown in FIG. 4 but is not visible in the pictured side view.

The patient's left hand is secured in wrist restraint 110, as pictured in FIG. 4, but note that in alternative configurations, wrist restraint 110 is structured to secure the patient's right hand as well. With reference to FIG. 4, the first end 116 of wrist restraint 110 is closed over the second end 117, such that the wrist restraint 110 substantially encircles the patient's hand. Also, as shown, fastener 114 attaches first end 116 of the wrist restraint 110 to the second end 117, maintaining the patient's wrist in position in the wrist restraint 110. Note that, as pictured in FIG. 4, when the patient's wrist is secured by wrist restraint 110, the patient's hand rests on or near the compression mechanism 103. Consequently, when a patient's wrist is secured in the wrist restraint 110—or in a restraint on an opposite side of wrist restraint 110—the patient's hand and arm are prevented from entering the path of the piston.

Furthermore, when the patient's hand is secured in wrist restraint 110, the patient's inner wrist interfaces with sensors 112. Because the wrist restraint 110 limits movement of the patient's wrist from its position, the patient's inner wrist maintains consistent contact with the sensors 112 during compressions. Consequently, the measurement capabilities described above with regard to FIG. 2 are enabled with the patient positioned as shown in FIG. 4.

FIG. 4 also shows the CPR device implemented with neck restraint 120. With the patient lying supine, and with the patient's head tending toward the surface on which the base member 102 rest, such as the ground, the pad 124 of neck restraint 120 interfaces with the nape of the patient's neck. And, as shown in FIG. 4, sensors 122 are disposed on pad 124 such that they also interface with the nape of the patient's neck. The neck restraint 120 is also secured to the support leg 104 of the CPR device as described above with regard to FIG. 1, with attachment end 126 looped around support leg 104. Although not pictured, configurations of neck restraint 120 such as the one illustrated in FIG. 4 include an additional attachment end 127, which is secured to a support leg 104 not visible in the pictured side view. Consequently, with the patient's neck interfacing with pad 124, and with the weight of the patient's head tending toward the surface on which the patient is laying, neck restraint 120 is tensioned. Due to the tension of neck restraint 120 when the patient is positioned within the CPR device 100, the sensors 122 remain in consistent contact with the skin of the patient's neck. Additionally, as shown in FIG. 4, the tension of neck restraint 120 when the patient is positioned within the CPR device 100 maintain the patient's shoulders at a distance from the support legs 104.

Sensors 122 for neck restraint 120, in configurations, comprise one or more sensing devices described above with regard to sensors 112 of FIG. 2. Sensors 122, in additional or alternative configurations, also comprise a sensing device for measuring a force, such as a strain gauge. In this way, in configurations implementing a sensing device for measuring a force, a force measured on the neck restraint 120 can be monitored during the performance of compressions. In situations where the CPR device 100 drifts, and thus the piston contacts the patient's chest in different locations, sensors 122 can detect a differing force on the neck restraint 120 and indicate that such drift has occurred. Additionally, although not illustrated in FIG. 4, in configurations of the CPR device 100, sensors 122 are electrically connected to the CPR device 100 such that measurements taken by sensors 122 are capable of being displayed to a rescuer. Additionally or alternatively, in configurations, measurements made by sensors 122 are used as feedback for the CPR device, just as described above with regard to sensors 112 of FIG. 2.

Sensors 122 for neck restraint 120 and sensors 112, 113 for wrist restraints 110, 111, in additional or alternative configurations, also comprise a sensing device for measuring an angle of the neck restraint 120 and wrist restraint 110, 111 relative to the CPR device 100. In this way, in configurations implementing a sensing device for measuring an angle of the restraints' positions, an angle measured on the neck restraint 120 or either of the wrist restraints 110, 111 can be monitored during the performance of compressions.

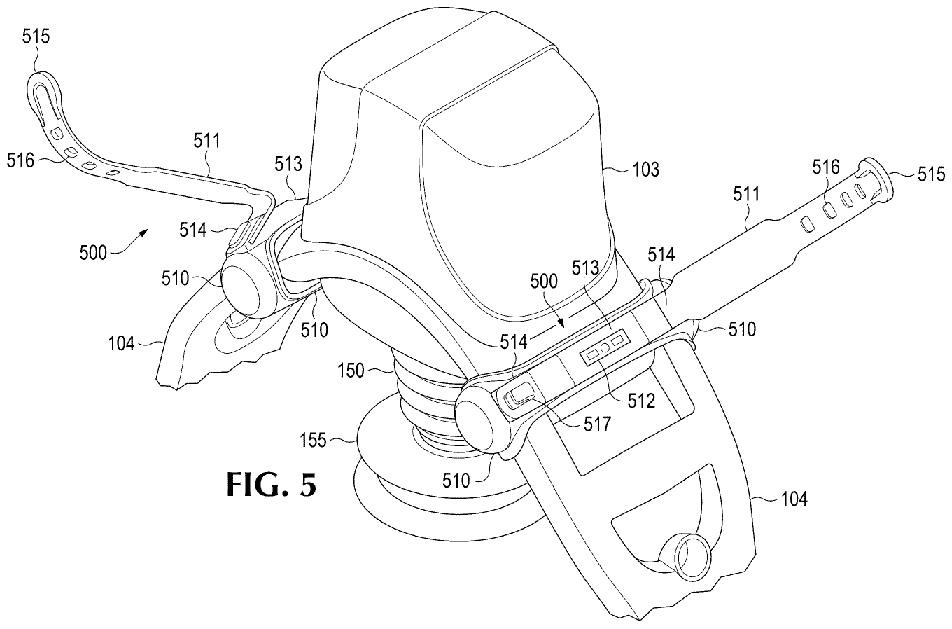

FIG. 5 shows a cutaway perspective view of a CPR device 100, such as the CPR device of FIG. 1, having a wrist restraint 500, according to an example configuration. In particular, FIG. 5 shows wrist restraint 500 in a position to receive a patient's wrist. As shown, wrist restraint 500 has a base portion 510 secured to the support leg 104 of CPR device 100 and a strap 511, with sensors 512 disposed on the base portion 510. Similar to alternative configurations just discussed, such as the examples illustrated in FIGS. 2 and 3, the location of sensors 512 corresponds to the location at which a patient's inner wrists interface with the base portion 510 of wrist restraint 500. Consequently, when one of patient's wrists is secured in wrist restraint 500, the skin of the patient's wrist is consistently in contact with the sensors 512.

In configurations, such as the example illustrated in FIG. 5, wrist restraint 500 comprises a wrist pad 513 on which sensors 512 are disposed. The wrist pad 513, in configurations is formed on a portion of the base portion 510. As shown, the strap 511 of wrist restraint 500 is an elongated strip having a fixed end 514 and an unfixed end 515, wherein the unfixed end 515 is configured to be attachable to and removable an end of the base portion 510. In this way, when a patient's wrist is positioned to be secured in place by wrist restraint 500, the patient's wrist is placed on the wrist pad 513, and the unfixed end 515 of strap 511 is brought over the patient's wrist such that the patient's wrist is substantially enclosed. For the purposes of this disclosure, “substantially enclose” means largely or essentially surrounding on all sides, without requiring perfect encasement. Specifically, the unfixed end 515 has a plurality of apertures 516 that are structured to receive a hook 517. Hook 517 is secured to base portion 510 at an end opposite the fixed end 514 of strap 511. Thus, when the unfixed end 515 is brought over the patient's wrist, the plurality of apertures 516 are brought toward the hook 517, and one of the apertures 516 can be selected to be receive the hook 517 and attach the unfixed end 515.

Because a plurality of apertures 516 are available to receive the hook 517, in configurations, wrist restraint 500 is adjustable to the size of a patient's wrist. For instance, an aperture nearest the unfixed end 515 of strap 511 provides the loosest fit, and an aperture nearest the fixed end 515 provides the tightest fit. Consequently, one of apertures 516 can be selected to ensure a snug fit of the strap 511 over the patient's wrist, depending on the size of the patient's wrist. If one of apertures 516 is selected such that the fit of the strap 511 is too loose, the wrist restraint 500 will enclose a space larger than the patient's wrist and potentially cause the patient's inner wrist to lift from its position on wrist pad 513. Ensuring a snug fit of the strap 511 over the patient's wrist, by selecting the appropriate aperture, accordingly ensures that the skin of the patient's inner wrist remains in constant contact with the sensors 512.

A variety of materials can be used to form wrist restraint 500, in configurations. For instance, in configurations, wrist restraint 500 is flexible and is formed of silicone rubber, polyurethane rubber, or a woven fabric like woven nylon. Other flexible materials are also used to form wrist restraint 500, in configurations, such as cordage, flexible metal cable, plastic webbing, or other known materials. In this way, wrist restraint can be conformable to a patient's wrist size and shape when the patient's wrist is secured within wrist restraint 500.

Referring again to FIG. 5, wrist restraint 500 is structured to secure one of a patient's wrists to the CPR device. In this way, wrist restraint 500 is structured to secure either of a patient's left or right hands, depending on the orientation of the patient's body within the CPR device. As shown in FIG. 5, configurations of the CPR device include two wrist restraints, with one attached to each support leg 104. In configurations implementing two of wrist restraint 500, one is thus configured to secure a patient's left wrist, while the other is configured to secure a patient's right wrist. In the structural components of wrist restraint 500 and closure of wrist restraint 500 may be understood as the same for each of two wrist restraints implemented as a pair.

Similar to the examples discussed above with regard to FIG. 2, wrist restraint 500 of FIG. 5 is structured to hold one of patient's wrists in place at a portion of the CPR device's support structure nearest the compression mechanism. Accordingly, wrist restraint 500 limits the motion of the corresponding arm and hand, preventing the patient's arm or hand from entering the path of piston 150 and suction cup 155 during compressions. Furthermore, because movement of the patient's arm and hand are limited by wrist restraint 500, the patient's inner wrists maintain consistent contact with the sensors 512 disposed on the wrist pad 513. Thus, implementation of sensors 512 with wrist restraint 500 provides for reliable measurement of physiological parameters or other conditions related to the compressions.

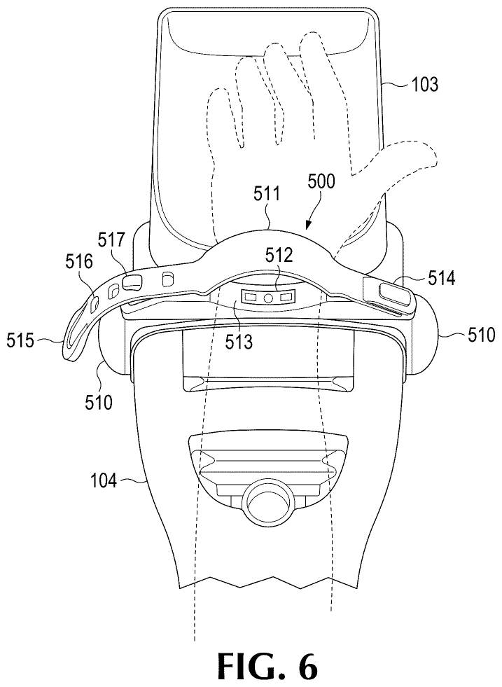

FIG. 6 shows a side view of the CPR device 100 with a representation of a patient's wrist shown positioned within the wrist restraint 500. Although one wrist restraint 500 is shown in FIG. 6, configurations of the CPR device 100 include a second wrist restraint 500 opposite the one illustrated in FIG. 6. As shown in FIG. 6, a patient's left hand is secured in wrist restraint 500, but, in alternative configurations, wrist restraint 500 is structured to secure the patient's right hand as well.

With reference to FIG. 6, the patient's inner wrist is positioned on wrist pad 513, and the unfixed end 515 of strap 511 is brought over the patient's wrist to substantially enclose the patient's wrist. One of apertures 516 receives the hook 517, such that the unfixed end 515 is attached to the base portion 510 of the wrist restraint 500. Thus, with both the fixed end 514 and the unfixed end 515 secured to the base portion 510, the patient's wrist is secured within the wrist restraint 500. Also, as shown, when the patient's wrist is secured by wrist restraint 500, the patient's hand rests on or near the compression mechanism 103. Consequently, when the patient's wrist is secured in the wrist restraint 500, the patient's hand and arm are prevented from entering the path of the piston.

Furthermore, because the wrist restraint 500 limits movement of the patient's wrist from its position, the patient's inner wrist maintains consistent contact with the sensors 512 during compressions. It should be noted that the discussion of sensor types and measurement functions presented above with regard to sensors 112 of FIG. 2 are applicable to sensors 512 of FIG. 5. Thus, any of the disclosed sensors and measurement capabilities described above with regard to FIG. 2 are enabled with the patient positioned in wrist restraint 500, as shown in FIG. 6.

Additionally, although not illustrated in FIG. 6, configurations of wrist restraint 500 can be implemented with a CPR device further including a neck restraint, such as the example neck restraint described above with regard to FIGS. 1 and 4.

In any of the described configurations, the disclosed restraints having sensors disposed on a portion of the restraints ensure that the patient's skin remains in contact with the sensors while a mechanical CPR device is used. Consequently, reliable streams of information and measurements are available to the rescuer, and to the CPR device as feedback, in configurations, throughout the performance of compressions.

### EXAMPLES

Illustrative examples of the disclosed technologies are provided below. A particular configuration of the technologies may include one or more, and any combination of, the examples described below.

Example 1 includes a restraint configured to secure a patient to a mechanical cardiopulmonary resuscitation (“CPR”) device, the restraint including a physiological sensor configured to detect a physiological parameter of the patient and to output a signal indicative of a value of the physiological parameter.

Example 2 includes the restraint of Example 1, in which the physiological sensor includes a non-invasive blood pressure cuff configured to detect a blood pressure of the patient.

Example 3 includes the restraint of any of Examples 1-2, in which the physiological sensor includes an electrocardiogram sensor.

Example 4 includes the restraint of any of Examples 1-3, in which the physiological sensor includes an oximeter configured to detect a blood oxygen saturation of the patient.

Example 5 includes the restraint of any of Examples 1-4, in which the physiological sensor includes a capnographic sensor configured to detect an end-tidal carbon-dioxide level of the patient.

Example 6 includes the restraint of any of Examples 1-5, in which the physiological sensor is configured to detect a pulse rate of the patient.

Example 7 includes the restraint of any of Examples 1-6, in which the restraint comprises a first end and a second end, the first end of the restraint being configured to couple to the second end of the restraint to secure the patient.

Example 8 includes the restraint of Example 7, further comprising a hook-and-loop fastener configured to removably couple the first end of the restraint to the second end of the restraint.

Example 9 includes the restraint of Example 7, further comprising a buckle configured to removably couple the first end of the restraint to the second end of the restraint.

Example 10 includes the restraint of any of Examples 1-6, in which the restraint comprises a bracelet configured to substantially encircle and secure a wrist of the patient.

Example 11 includes the restraint of any of Examples 1-6, in which the restraint comprises a base portion and a strap having a fixed end and an unfixed end, the fixed end being fixed to a first end of the base portion, and the unfixed end being attachable to and removable from a second end of the base portion.

Example 12 includes the restraint of Example 11, in which the strap has a plurality of apertures disposed along the unfixed end, and in which the plurality of apertures is configured to receive a hook secured to the second end of the base portion.

Example 13 includes the restraint of any of Examples 1-6, in which the restraint comprises a glove, and the physiological sensor is positioned to interface with the patient's fingers.

Example 14 includes the restraint of any of Examples 1-6, in which the restraint is further configured to interface with the nape of a patient's neck, and in which the sensor is disposed on the restraint such that the sensor contacts the skin of the patient's neck.

Example 15 includes a mechanical cardiopulmonary resuscitation (“CPR”) device comprising: a compression mechanism configured to perform successive CPR compressions to a chest of a patient; a support structure configured to position the compression mechanism at a first distance from the chest of the patient; a restraint configured to secure the patient to the support structure; and a physiological sensor on the restraint, the physiological sensor configured to detect a physiological parameter of the patient and to output a signal indicative of a value of the physiological parameter.

Example 16 includes the mechanical CPR device of Example 15, in which the physiological sensor includes a non-invasive blood pressure cuff configured to detect a blood pressure of the patient.

Example 17 includes the mechanical CPR device of any of Examples 15-16, in which the physiological sensor includes an electrocardiogram sensor.

Example 18 includes the mechanical CPR device of any of Examples 15-17, in which the physiological sensor includes an oximeter configured to detect a blood oxygen saturation of the patient.

Example 19 includes the mechanical CPR device of any of Examples 15-18, in which the physiological sensor includes a capnographic sensor configured to detect an end-tidal carbon-dioxide level of the patient.

Example 20 includes the mechanical CPR device of any of Examples 15-19, in which the physiological sensor is configured to detect a pulse rate of the patient.

Example 21 includes the mechanical CPR device of any of Examples 15-20, in which the restraint comprises a first end and a second end, the first end of the restraint being configured to couple to the second end of the restraint to secure the patient.

Example 22 includes the mechanical CPR device of Example 21, further comprising a hook-and-loop fastener configured to removably couple the first end of the restraint to the second end of the restraint.

Example 23 includes the mechanical CPR device of Example 21, further comprising a buckle configured to removably couple the first end of the restraint to the second end of the restraint.

Example 24 includes the mechanical CPR device of any of Examples 15-20, in which the restraint comprises a bracelet configured to substantially encircle and secure a wrist of the patient.

Example 25 includes the mechanical CPR device of any of Examples 15-20, in which the restraint is further configured to secure a wrist of the patient to the support structure at a second distance from the chest of the patient.

Example 26 includes the mechanical CPR device of any of Examples 15-20, in which the restraint comprises a base portion and a strap having a fixed end and an unfixed end, the fixed end being fixed to a first end of the base portion, and the unfixed end being attachable to and removable from a second end of the base portion.

Example 27 includes the mechanical CPR device of Example 26, in which the strap has a plurality of apertures disposed along the unfixed end, and in which the plurality of apertures is configured to receive a hook secured to the second end of the base portion.

Example 28 includes the mechanical CPR device of any of Examples 15-20, in which the restraint comprises a glove, and the physiological sensor is positioned to interface with the patient's fingers.

Example 29 includes the mechanical CPR device of any of Examples 15-20, in which the restraint is further configured to interface with the nape of a patient's neck, and in which the sensor is disposed on the restraint such that the sensor contacts the skin of the patient's neck.

Example 30 includes the mechanical CPR device of any of Examples 15-29, in which the support structure comprises: a backboard configured to be placed underneath the patient; and a support leg configured to support the chest compression mechanism at a distance from the backboard.

Example 31 includes the mechanical CPR device of Example 30, in which the restraint is further configured to secure shoulders of the patient to the support structure at a third distance from the support leg.

Example 32 includes the mechanical CPR device of any of Examples 15-30, in which the compression mechanism comprises: a piston; and a driver coupled to the piston and configured to extend the piston toward the chest of the patient and retract the piston away from the chest of the patient.

Example 33 includes the mechanical CPR device of Example 32, further comprising a controller configured to cause the driver during a treatment session to repeatedly: extend the piston from a first position to a compression position to compress the chest of the patient according to a treatment profile, and retract the piston from the compression position according to the treatment profile.

Example 34 includes the mechanical CPR device of Example 33, the controller further configured to start the treatment profile based, at least in part, on the signal indicative of the value of the physiological parameter detected by the physiological sensor.

Example 35 includes the mechanical CPR device of any of Examples 33-34, the controller further configured to stop the treatment profile based, at least in part, on the signal indicative of the value of the physiological parameter detected by the physiological sensor.

Example 36 includes the mechanical CPR device of any of Examples 33-35, the controller further configured to pause the treatment profile based, at least in part, on the signal indicative of the value of the physiological parameter detected by the physiological sensor.

Example 37 includes the mechanical CPR device of any of Examples 33-36, the controller further configured to modify the treatment profile based, at least in part, on the signal indicative of the value of the physiological parameter detected by the physiological sensor.

Example 38 includes a mechanical cardiopulmonary resuscitation (“CPR”) device comprising: a compression mechanism configured to perform successive CPR compressions to a chest of a patient, the compression mechanism comprising: a piston, and a driver coupled to the piston and configured to extend the piston toward the chest of the patient and retract the piston away from the chest of the patient; a support structure configured to position the compression mechanism at a first distance from the chest of the patient; a restraint configured to secure the patient to the support structure; a sensor on the restraint, the sensor configured to detect a compression parameter and to output a signal indicative of a value of the compression parameter; and a controller configured to cause the driver during a treatment session to repeatedly: extend the piston from a first position to a compression position to compress the chest of the patient according to a treatment profile, and retract the piston from the compression position according to the treatment profile.

Example 39 includes the mechanical CPR device of Example 38, in which the restraint is further configured to interface with the nape of a patient's neck, and in which the sensor is disposed on the restraint such that the sensor contacts the skin of the patient's neck.

Example 40 includes the mechanical CPR device of any of Examples 38-39, the controller further configured to start the treatment profile based, at least in part, on the signal indicative of the value of the compression parameter detected by the sensor.

Example 41 includes the mechanical CPR device of any of Examples 38-40, the controller further configured to stop the treatment profile based, at least in part, on the signal indicative of the value of the compression parameter detected by the sensor.

Example 42 includes the mechanical CPR device of any of Examples 38-41, the controller further configured to pause the treatment profile based, at least in part, on the signal indicative of the value of the compression parameter detected by the sensor.

Example 43 includes the mechanical CPR device of any of Examples 38-42, the controller further configured to modify the treatment profile based, at least in part, on the signal indicative of the value of the compression parameter detected by the sensor.

Example 44 includes the mechanical CPR device of any of Examples 39-43, in which the sensor is a strain gauge configured to measure a force exerted on the restraint and output a signal indicative of the measured force.

Example 45 includes the mechanical CPR device of Example 44, the controller further configured to detect that the compression mechanism has drifted from a desired location on the chest of the patient based, at least in part, on the signal indicative of the measured force.

Example 46 includes the mechanical CPR device of any of Examples 39-43, in which the sensor is an angle gauge configured to measure an angle of the restraint relative to the mechanical CPR device and output a signal indicative of the measured angle.

Example 47 includes the mechanical CPR device of any of Examples 38-46, in which the sensor includes a non-invasive blood pressure cuff configured to detect a blood pressure of the patient.

Example 48 includes the mechanical CPR device of any of Examples 38-47, in which the sensor includes an electrocardiogram sensor.

Example 49 includes the mechanical CPR device of any of Examples 38-48, in which the sensor includes an oximeter configured to detect a blood oxygen saturation of the patient.

Example 50 includes the mechanical CPR device of any of Examples 38-49, in which the sensor includes a capnographic sensor configured to detect an end-tidal carbon-dioxide level of the patient.

Example 51 includes the mechanical CPR device of any of Examples 38-50, in which the sensor is configured to detect a pulse rate of the patient.

Example 52 includes the mechanical CPR device of any of Examples 38-51, in which the restraint comprises a first end and a second end, the first end of the restraint being configured to couple to the second end of the restraint to secure the patient.

Example 53 includes the mechanical CPR device of Example 52, further comprising a hook-and-loop fastener configured to removably couple the first end of the restraint to the second end of the restraint

Example 54 includes the mechanical CPR device of Example 52, further comprising a buckle configured to removably couple the first end of the restraint to the second end of the restraint.

Example 55 includes the mechanical CPR device of any of Examples 38-51, in which the restraint comprises a bracelet configured to substantially encircle and secure a wrist of the patient.

Example 56 includes the mechanical CPR device of any of Examples 38-51, in which the restraint comprises a base portion and a strap having a fixed end and an unfixed end, the fixed end being fixed to a first end of the base portion, and the unfixed end being attachable to and removable from a second end of the base portion.

Example 57 includes the mechanical CPR device of Example 56, in which the strap has a plurality of apertures disposed along the unfixed end, and in which the plurality of apertures is configured to receive a hook secured to the second end of the base portion.

Example 58 includes the mechanical CPR device of any of Examples 38-51, in which the restraint comprises a glove, and the sensor is positioned to interface with the patient's fingers.

Aspects may operate on a particularly created hardware, on firmware, digital signal processors, or on a specially programmed general purpose computer including a processor operating according to programmed instructions. The terms “controller” or “processor” as used herein are intended to include microprocessors, microcomputers, ASICs, and dedicated hardware controllers. One or more aspects may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, RAM, etc. As will be appreciated by one of skill in the art, the functionality of the program modules may be combined or distributed as desired in various configurations. In addition, the functionality may be embodied in whole or in part in firmware or hardware equivalents such as integrated circuits, field programmable gate arrays (FPGA), and the like. Particular data structures may be used to more effectively implement one or more aspects of the disclosed systems and methods, and such data structures are contemplated within the scope of computer executable instructions and computer-usable data described herein.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Also, directions such as “vertical,” “horizontal,” “right,” and “left” are used for convenience and in reference to the views provided in figures. But the CPR device may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

We claim:

1. A restraint configured to secure a patient to a mechanical cardiopulmonary resuscitation (“CPR”) device, the restraint including a physiological sensor configured to detect a physiological parameter of the patient and to output a signal indicative of a value of the physiological parameter.

2. The restraint of claim 1, in which the physiological sensor includes a non-invasive blood pressure cuff configured to detect a blood pressure of the patient.

3. The restraint of claim 1, in which the physiological sensor includes an electrocardiogram sensor.

4. The restraint of claim 1, in which the physiological sensor includes an oximeter configured to detect a blood oxygen saturation of the patient.

5. The restraint of claim 1, in which the physiological sensor includes a capnographic sensor configured to detect an end-tidal carbon-dioxide level of the patient.

6. The restraint of claim 1, in which the physiological sensor is configured to detect a pulse rate of the patient.

7. The restraint of claim 1, in which the restraint comprises a first end and a second end, the first end of the restraint being configured to couple to the second end of the restraint to secure the patient.

8. The restraint of claim 7, further comprising a hook-and-loop fastener configured to removably couple the first end of the restraint to the second end of the restraint.

9. The restraint of claim 7, further comprising a buckle configured to removably couple the first end of the restraint to the second end of the restraint.

10. The restraint of claim 1, in which the restraint comprises a bracelet configured to substantially encircle and secure a wrist of the patient.

11. The restraint of claim 1, in which the restraint comprises a base portion and a strap having a fixed end and an unfixed end, the fixed end being fixed to a first end of the base portion, and the unfixed end being attachable to and removable from a second end of the base portion.

12. The restraint of claim 11, in which the strap has a plurality of apertures disposed along the unfixed end, and in which the plurality of apertures is configured to receive a hook secured to the second end of the base portion.

13. The restraint of claim 1, in which the restraint comprises a glove, and the physiological sensor is positioned to interface with the patient's fingers.

14. The restraint of claim 1, in which the restraint is further configured to interface with the nape of a patient's neck, and in which the sensor is disposed on the restraint such that the sensor contacts the skin of the patient's neck.

15. A mechanical cardiopulmonary resuscitation (“CPR”) device comprising:
a compression mechanism configured to perform successive CPR compressions to a chest of a patient;
a support structure configured to position the compression mechanism at a first distance from the chest of the patient;
a restraint configured to secure the patient to the support structure; and
a physiological sensor on the restraint, the physiological sensor configured to detect a physiological parameter of the patient and to output a signal indicative of a value of the physiological parameter.

16. The mechanical CPR device of claim 15, in which the physiological sensor includes a non-invasive blood pressure cuff configured to detect a blood pressure of the patient.

17. The mechanical CPR device of claim 15, in which the physiological sensor includes an electrocardiogram sensor.

18. The mechanical CPR device of claim 15, in which the physiological sensor includes an oximeter configured to detect a blood oxygen saturation of the patient.

19. The mechanical CPR device of claim 15, in which the physiological sensor includes a capnographic sensor configured to detect an end-tidal carbon-dioxide level of the patient.

20. The mechanical CPR device of claim 15, in which the physiological sensor is configured to detect a pulse rate of the patient.
